(19) United States
(12) Patent Application Publication
(10) Pub. No.: US 2014/0380251 A1
(43) Pub. Date: Dec. 25, 2014

(54) METHOD AND DEVICE FOR AUGMENTED HANDLING OF MULTIPLE CALLS WITH GESTURES

(71) Applicant: MOTOROLA MOBILITY LLC, Chicago, IL (US)

(72) Inventors: Rachid M. Alameh, Crystal Lake, IL (US); Hisashi D. Watanabe, Lake Forest, IL (US); Jason P. Wojack, Libertyville, IL (US)

(73) Assignee: MOTOROLA MOBILITY LLC, Chicago, IL (US)

(21) Appl. No.: 14/248,368

(22) Filed: Apr. 9, 2014

Related U.S. Application Data
(60) Provisional application No. 61/836,792, filed on Jun. 19, 2013.

(51) Int. Cl. G06F 3/01; H04W 4/16

(52) U.S. Cl. CPC G06F 3/017; H04W 4/16
USPC 715/863

(57) ABSTRACT

A wireless communication device (200) and method (300) with augmented handling of multiple calls with intuitive gestures is disclosed. The method (300) can provide the steps of: providing (310) a wireless communication device with a sensing assembly; receiving (320) an incoming voice call while on an existing voice call; and evaluating (330) a gesture, to send the incoming voice call to voicemail via a send gesture, to answer the incoming voice call via an answer gesture or conference the existing voice call with the incoming voice call via a conference gesture. Advantageously, the method 300 provides a simplified way to handle multiple calls that can minimize distractions and simplifies actuating of commands via gestures.

### BACKGROUND

1. Field

The present disclosure relates to a method and device for augmented handling of multiple calls with gestures.

2. Introduction

There are a number of ways to handle multiple calls for wireless communication devices. Most require a user's attention, touch or voice, which are often inconvenient and can cause user distraction. Voice is not practical when in a crowd. In more detail, in conventional mobile devices, when a device is engaged in an active call, and another call comes in, a user has to switch back and forth between the two numbers to handle which call to proceed with and which to dismiss. This process entails device touch interface, manual communication with caller, conversation interruptions, and call handling delays. This gets excessive and can be distracting when user is pre-occupied with other tasks, near other people, in noisy environments, listening to the radio, or device is in placed in a dock out of the user's reach.

Thus, there is a need in connection with handling multiple calls for wireless communication devices, to eliminate or minimize touch commands and manual actuation of commands.

Thus, there is a need for augmented handling of multiple calls with intuitive gestures, for electronic devices, such as wireless communication devices.

There is also a need for simplified and intuitive ways to effectively handle multiple incoming calls, quickly, easily and reliably, without requiring pain staking attention to the operation of the device.

Thus, a method and device with augmented ways of handling multiple calls with intuitive gestures that addresses these needs, would be considered an improvement in the art.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary block diagram of a communication system including a wireless communication device shown in a landscape mode, according to one embodiment.

FIG. 2 is an exemplary block diagram of a wireless communication device according to one embodiment.

FIG. 3 is an exemplary block diagram of a wireless communication method according to one embodiment.

FIG. 4 is an exemplary partial perspective view of a sensing assembly for use in a wireless communication device, according to one embodiment.

FIG. 5 is an exemplary frontal view of a wireless communication device, in portrait mode, showing an object, in the form of a hand, being pulled, in a negative x direction according to one embodiment.

FIG. 6 is an exemplary frontal view of a wireless communication device in FIG. 1, showing an object, in the form of a hand, being pushed, in a positive x direction according to one embodiment.

FIG. 7 is an exemplary frontal view of a wireless communication device in FIG. 1, showing an object, in the form of a hand, being moved downwardly, in a negative y direction, as shown by arrow 510 or moved in a clockwise motion, as shown by arrow 512, according to one embodiment.

FIG. 8 is an exemplary graph of intensity versus time curves 800, 802, 804, and 806, which represent measured signal sets corresponding to respective phototransmitters 486, 484, 488, and 490 for a slide gesture performed by an object such as a hand that moves above sensing assembly of FIG. 4, and specifically illustrates a slide gesture of an object moving from the right side to the left side, as shown by arrow 502 in FIG. 5, across, a wireless communication device, according to one embodiment.

FIG. 9 is an exemplary graph of intensities versus time curves 900, 902, 904, and 906 for a slide gesture by an object moving from top to bottom, as shown as arrow 510 in FIG. 7, across the sensing assembly 400 (denoted here as a vertical gesture), wherein the curves 900, 902, 904, and 906 represent measured signal sets corresponding to respective phototransmitters 484, 486, 490, and 488, for use in a wireless communication device, according to one embodiment.

### DETAILED DESCRIPTION

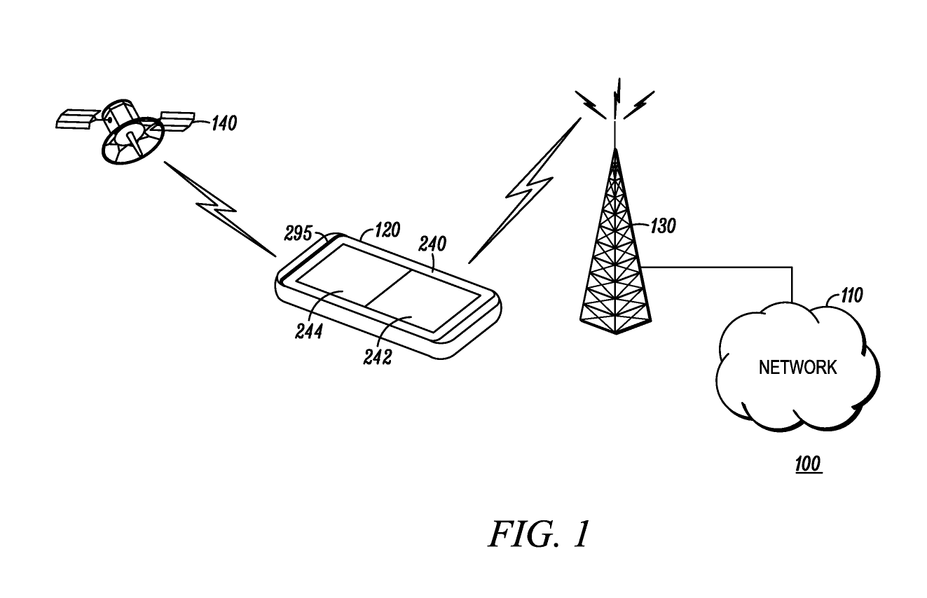

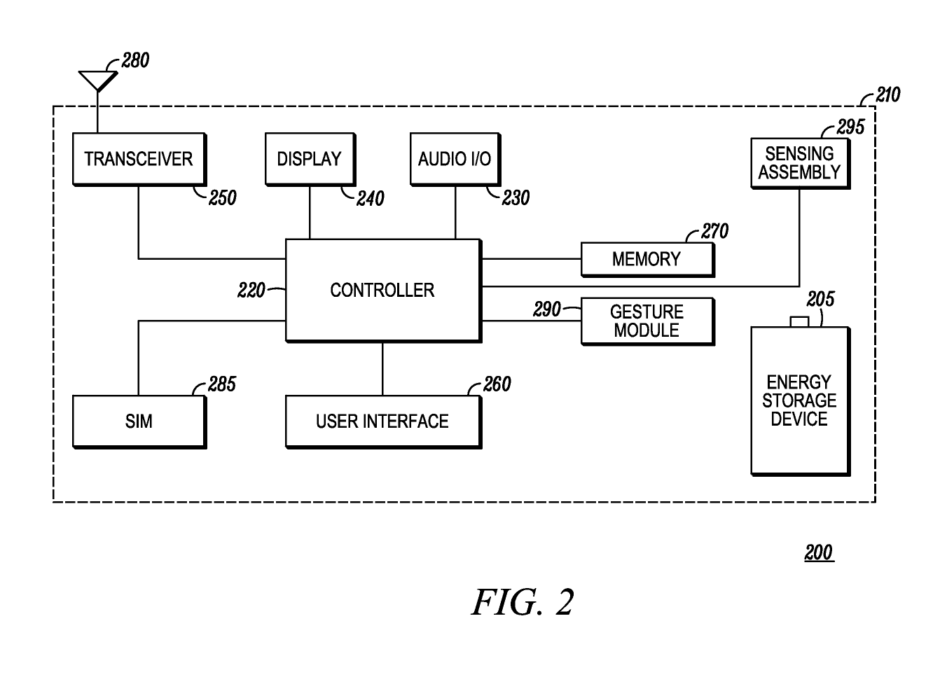

FIG. 1 is an exemplary block diagram of a system 100 according to one embodiment. The system 100 can include a network 110, a terminal 120, and a base station 130. The terminal 120 may be a wireless communication device, such as a wireless telephone, a wearable device, a cellular telephone, a personal digital assistant, a pager, a personal computer, a tablet, a selective call receiver, or any other device that is capable of sending and receiving communication signals on a network including a wireless network. The network 110 may include any type of network that is capable of sending and receiving signals, such as wireless signals. For example, the network 110 may include a wireless telecommunications network, a cellular telephone network, a Time Division Multiple Access (TDMA) network, a Code Division Multiple Access (CDMA) network, Global System for Mobile Communications (GSM), a Third Generation (3G) network, a Fourth Generation (4G) network, a satellite communications network, and other like communications systems. More generally, network 110 may include a Wide Area Network (WAN), a Local Area Network (LAN) and/or a Personal Area Network (PAN). Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving communication signals. In operation, the terminal 120 can include a wireless communication device which can communicate with the network 110 and with other devices on the network 110 by sending and receiving wireless signals via the base station 130, which may also comprise local area, and/or personal area access points, as detailed more fully herein. The terminal 120 is shown being in communication with a global positioning system (GPS) 140 satellite, global navigation satellite system (GNSS) or the like, for position sensing and determination. FIG. 2 is an exemplary block diagram of a wireless communication device 200 (hereafter used interchangeably with electronic device and terminal 120) configured with an energy storage device, battery or module 205, such as in the terminal 120, for example. The wireless communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, an antenna 280 coupled to the housing 210 and the transceiver 250, and a removable subscriber module 285 coupled to the controller 220.

As shown in FIG. 2, the wireless communication device 200 further includes a gesture module 290 and sensing assembly 295, as detailed below.

In one embodiment, the module 290 can reside within in the controller 220, can reside within the memory 270, can be an autonomous module, can be software, can be hardware, or can be in any other format useful for a module on a wireless communication device 200.

The display 240 can be a liquid crystal display (LCD), a light emitting diode (LED) display, a plasma display, a touch screen display or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch screen or pad, a joystick, an additional display, or any other device useful for providing an interface between a user and an electronic device. The memory 270 may include a random access memory, a read only memory, an optical memory or any other memory that can be coupled to a wireless communication device.

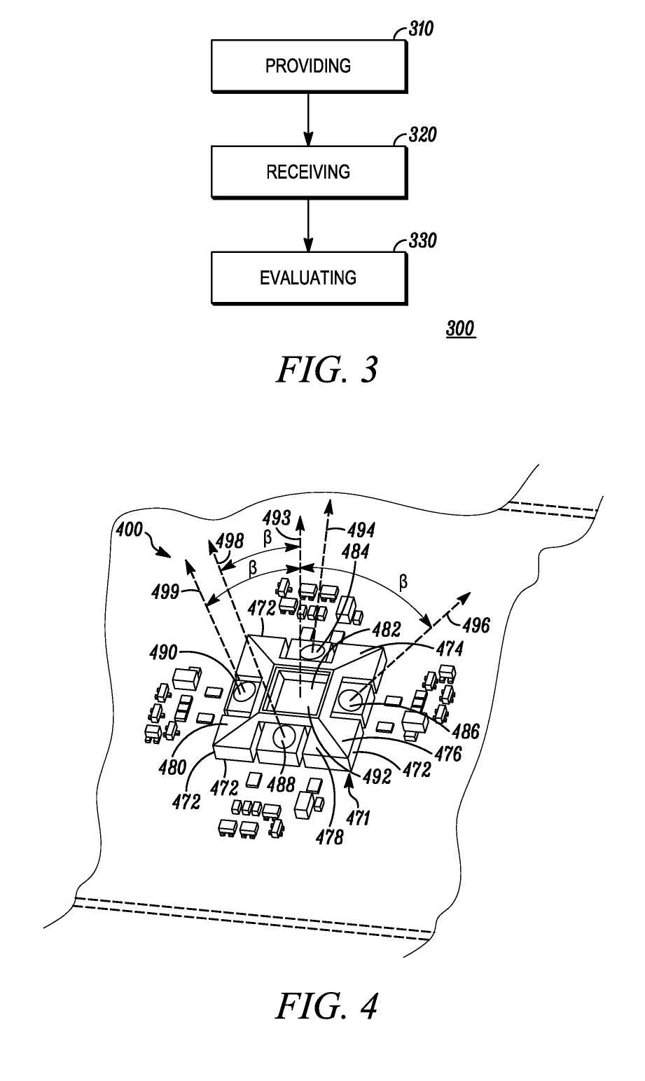

A block diagram of a wireless communication method 300, is shown in FIG. 3. In its simplest form, the method 300 can provide the steps of: providing 310 a wireless communication device with a sensing assembly; receiving 320 an incoming voice call while on an existing voice call; and evaluating 330 a gesture, to send the incoming voice call to voicemail via a send gesture, to answer the incoming voice call via an answer gesture or conference the existing voice call with the incoming voice call via a conference gesture.

Advantageously, the method 300 provides a simplified way to handle multiple calls that can minimize distractions and simplifies actuating of commands via gestures. The method 300 can utilize intuitive gesturing to effectively handle multiple incoming calls, quickly, easily and reliably, without requiring a user's undivided attention when using touch screens, in one embodiment.

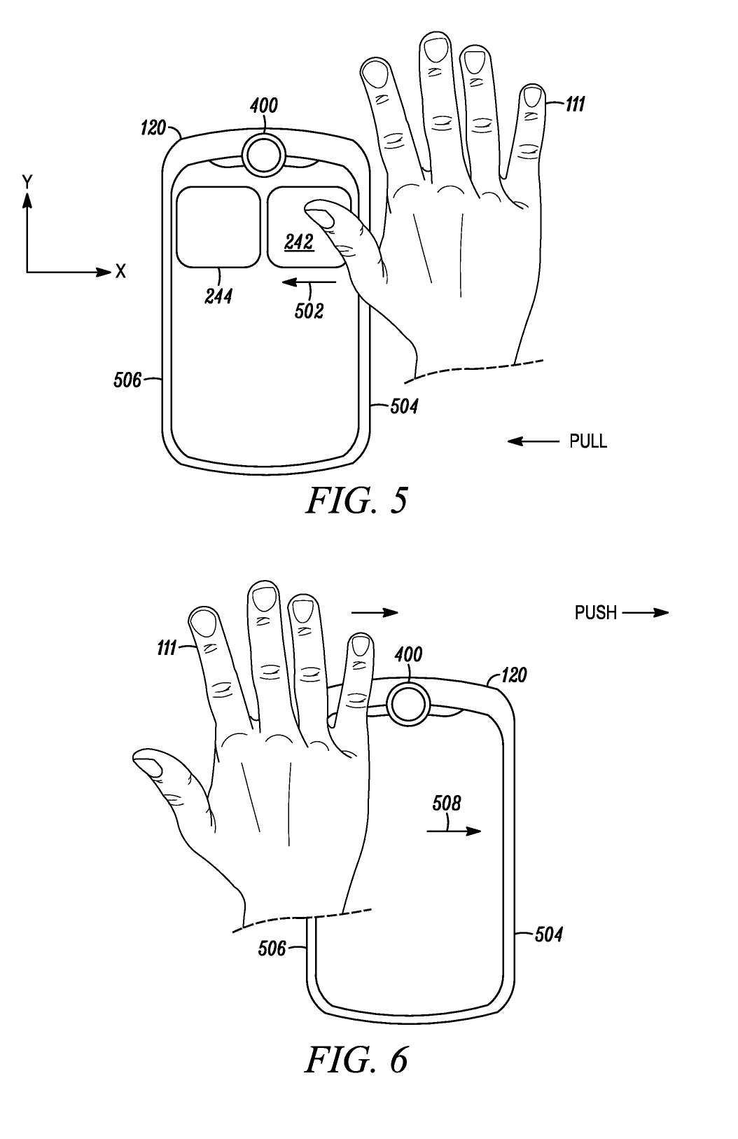

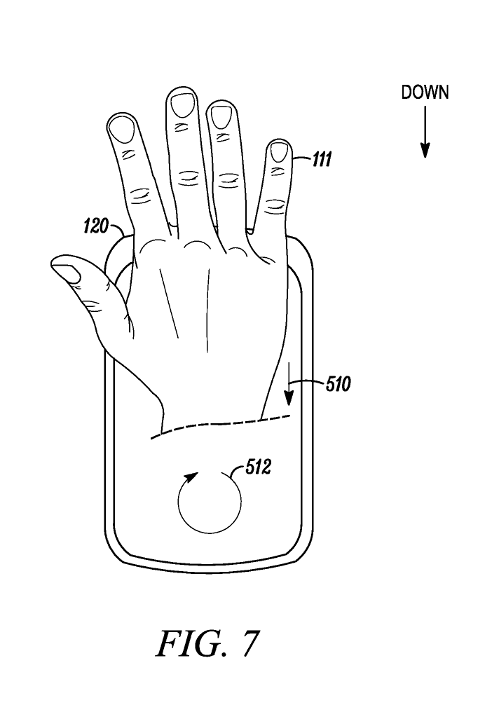

In one use case, the receiving step 320 can include presenting a representation of the incoming voice call and a representation of the existing voice call, defining a first region 242 in the form of an incoming call region and a second region 242 in the form of an existing call region, in a substantially side by side arrangement, on a display 240, as shown in landscape mode, in FIG. 1. The answer gesture can comprise passing an object, such as a hand, in a negative X direction, as shown by arrow 502 in FIG. 5. The send gesture can comprise passing an object, such as a hand, in a positive X direction, as shown by arrow 508 in FIG. 6. And, the conference gesture can comprise passing an object in a negative Y direction, as shown by arrow 510 in FIG. 7 or passing an object in a circular direction, as shown by arrow 512 in FIG. 7. In one embodiment, the send gesture, the answer gesture and the conference gesture are each different from another and are intuitive to a user, to provide clear gesture commands for enhanced multiple call handling and intuitive user operation.

In one embodiment, the evaluating step 330 includes utilizing the sensing assembly 295 to determine which gesture was performed. As should be understood, the sensing assembly 295 can vary, as will be detailed below. It can be a modular or it can include discrete components located at various locations. In more detail, the evaluating step 330 includes: utilizing the sensing assembly 295, to determine which gesture was performed, and actuating a command to send the incoming voice call to voicemail in response to the send gesture, to answer the incoming voice call in response to the answer gesture or conference the existing voice call with the incoming voice call in response to the conference gesture. This feature provides a simple way to quickly and easily actuate and execute a user command, based on a certain gesture.

The evaluating step 330 can include an object touching the display, the display including a touch screen display. As should be understood, Applicant's intuitive gesturing can vary. In a preferred use case, it can be touch free, and in an alternative embodiment, it can include touch, by use of a touch screen display interface.

In an alternative embodiment, a wireless communication device 120 or 200 is shown, for example, in FIGS. 1 and 2. It can include: a housing 210 including a front portion including a display 240 and sensing assembly 295; a controller 230 coupled to the housing 210, the controller 230 configured to control the operations of a wireless communication device; and a gesture module 290 configured to receive an incoming voice call while on an existing voice call; and evaluate a gesture, to send the incoming voice call to voicemail via a send gesture, as shown in FIG. 5, to answer the incoming voice call via an answer gesture, as shown in FIG. 6 or conference the existing voice call with the incoming voice call via a conference gesture, as shown in FIG. 7. Advantageously, the device 120 or 200 provides a simplified way to handle multiple calls that can minimize distractions and simplifies actuating of commands via gestures. The device can utilize intuitive gesturing to effectively handle multiple incoming calls, quickly, easily and reliably, without requiring a user's undivided attention, such as when using touch screens, in one embodiment.

As shown in FIGS. 1 and 5, the display 240 includes a first representation of the incoming voice call and a second representation of the existing voice call, defining a first region 242, such as an incoming call region and a second region 244, such as an existing call region, respectively, located adjacent to each other on the display. This embodiment is adapted for a right handed user, using intuitive right handed gestures. As should be understood, the first 242 and second regions 244 could be switched for a left handed user, holding the device with a right hand and making intuitive gestures with a left hand.

Also, the wireless communication device or terminal 120 can include a display 240 configured to present content in a portrait mode, as shown in FIGS. 5-8, and a landscape mode, as shown in FIG. 1.

The wireless communication device 120 can include the send gesture comprising passing an object in a positive X direction, as arrow 508, the answer gesture comprising passing an object in a negative X direction, as arrow 502, and the conference gesture comprising passing an object in a negative Y direction, arrow 510, or passing an object in a circular direction, arrow 512, above the wireless communication device. Advantageously, a user can easily handle multiple calls, while not looking at the device, such as when working out, bike riding and the like. In one embodiment, the gesture module 290 is coupled to the sensing assembly 295, to determine which gesture was performed, and is configured to actuate a command: to send the incoming voice call to voicemail in response to the send gesture, to answer the incoming voice call in response to the answer gesture or conference the existing voice call with the incoming voice call in response to the conference gesture. This structure provides a reliable structure, for reliable call handling of a device.

In an alternative embodiment, the display 240 includes a touch screen display that can read touch gestures, represented by arrows 502, 508, 510 and 512, as previously detailed.

As shown in FIG. 4, a sensing assembly 400 can be employed with a four-sided pyramid-type shape with a housing structure 471 having four edges forming a square perimeter 472, and four inclined surfaces 474, 476, 478, and 480. The sensing assembly 400 includes a top surface 482 from which each of the respective four inclined surfaces 474, 476, 478, and 480 slope downwardly. The sensing assembly 400 further includes phototransmitters 484, 486, 488, and 490, such as photo-LEDs, each situated along a respective one of the inclined surfaces 474, 476, 478, and 480, and a photoreceiver 492, such as a photodiode, is mounted on the top surface 482.

Thus, the sensing assembly 400 includes multiple phototransmitters arranged about (and equally spaced about) a single photoreceiver that is centrally positioned in between the phototransmitters.

Further shown in FIG. 4, is a center axis of reception of the photoreceiver 492 which is aligned with a perpendicular axis 493 normally extending from the top surface 482, which is angularly spaced apart by an angle 13 from each first, second, third, and fourth center axes of transmission 494, 496, 498, and 499 of the respective phototransmitters 484, 486, 488, and 490. In other embodiments, one or more of the phototransmitters can be arranged so as to have an associated angle different than the others. In one embodiment, the sensing assembly 400 can include the respective phototransmitters 484, 486, 488, 490 each being vertically rotationally offset relative to the perpendicular axis 493 (and thus relative to the center axis of reception of the photoreceiver 492) in a manner corresponding to the slopes of the respective inclined surfaces 474, 476, 478, 480 with which the phototransmitters are associated. Also, the photoreceiver 492 is capable of receiving light within a much wider range of angles relative to the perpendicular axis 493 than the respective phototransmitters 484, 486, 488, 490 transmit light relative to their respective center axes of transmission 494, 496, 498, 499, and operation of the sensing assembly 400 again is predicated upon the assumption that the photoreceiver 492 is capable of receiving light that is reflected off of an external object that may have been transmitted by any one or more of the phototransmitters 484, 486, 488, 490.

As understood by those skilled in the art, the photoreceiver 492 need not extend up to the very outer surfaces of the sensing assembly, and can be positioned by a transparent window or wall, so as to provide protection for the photoreceiver and/or provide desired optical properties. Further, depending upon the embodiment, the photoreceivers can take a variety of forms including, for example, angle-diversity receivers or fly-eye receivers. Depending upon the embodiment, various filters can be employed above the photoreceivers and/or phototransmitters to filter out undesired light. Different filters can in some circumstances be employed with different ones of the phototransmitters/photoreceivers, for example, to allow for different colors of light to be associated with, transmitted by, or received by, the different components.

In one embodiment, the sensing assembly 400 can include multiple phototransmitters and/or photoreceivers and be co-located in a single or shared small region and can be mounted on a circuit board along with other circuit components.

Also, the sensing assembly 400 can potentially be discrete structures that can be implemented in relation to many different types of existing electronic devices, by way of a relatively simple installation process, as add-on or even after-market devices. Generally a slide or swipe gestures can be defined to be movement of an object in a defined plane across an electronic device, and preferably at a generally constant distance from (typically above) an electronic device. For example, FIG. 5 illustrates a side-to-side slide gesture performed by movement of a user's hand 111 in an xy plane and in a negative x direction (as indicated by arrow 502) from a first side 504 of an electronic device 1200, across the electronic device and preferably across the sensing assembly 400, to a second side 506 of the electronic device 120.

Similarly, FIG. 6 illustrates a side-to-side slide gesture performed by movement of a user's hand 111 in an xy plane and in a positive x direction (as indicated by arrow 508) from the second side 506 and preferably across the sensing assembly 400, to the first side 504 of the electronic device 120.

Similarly, a top-to-bottom (or bottom to top) slide gesture can be defined by movement of an object across the sensing device such as from a top side of the electronic device in a negative y direction (as indicated by arrow 510) to a bottom of the electronic device, as shown in FIG. 7. In an alternative embodiment, a positive y direction from bottom to top can be used.

Basically in order to detect gestures, one or more phototransmitters of the sensing assembly are controlled by a processor, to emit light over sequential time periods as a gesture is being performed, and one or more photoreceivers of the sensing assembly receive any light that is emitted from a corresponding phototransmitter and is then reflected by the object (prior to being received by a photoreceiver) to generate measured signals. The processor, which preferably includes an analog to digital converter, receives these measured signals from the one or more photoreceivers, and converts them to a digital form, such as 10 bit digital measured signals. The processor then analyzes all or a portion of these digital measured signals over time to detect the predefined gesture. The analysis can be accomplished by determining specific patterns or features in one or more of measured signal sets or modified or calculated signal sets. In some cases, the timing of detected patterns or features in a measured signal set can be compared to the timing of detected patterns or features in other measured signal sets. Other data manipulation can also be performed. The predefined basic gestures can be individually detected or can be detected in predefined combinations, allowing for intuitive and complex control of the electronic device.

As previously detailed, a specific gesture can be used to intuitively, easily and quickly select one or more items displayed on a display screen of the electronic device in a touchless manner, in a preferred embodiment. Since predefined gestures are detectable in a three dimensional space, this allows for various menus or displays of items such as contacts, icons or pictures, to be arranged in various desired manners on a display screen of the electronic device. Specific items selectable through the use of one or more predefined gestures including push/pull (x direction), (y direction), and circular or hover type gestures, for controlling and providing commands to an electronic device.

As mentioned earlier, various gesture detection routines including various processing steps can be performed to evaluate the measured signals. For example, assuming the use of a sensing assembly 400 as shown in FIG. 4

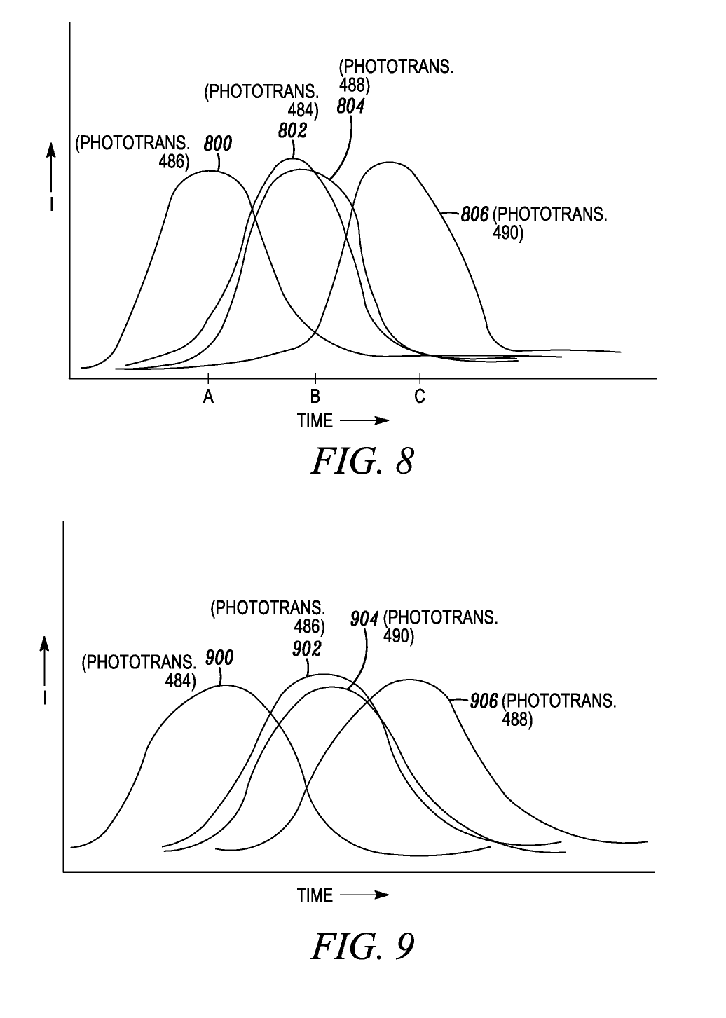

With respect to a slide gesture, assuming that a z-axis distance of the object from the sensing assembly remains relatively constant, then the occurrence of a slide gesture and its direction can be determined by examining the timing of the occurrence of intensity peaks in corresponding measured signal sets with respect to one or more of the other measured signal sets. As an object gets closer to a specific phototransmitter's central axis of transmission, the more light from that transmitter will be reflected and received by a photoreceiver, such as the photoreceiver 492 of sensing assembly 400 shown in FIG. 4. The timing of the intensity peaks in each measured signal set with respect to the other measured signal sets provides information regarding the direction of travel of the object. For example, FIG. 8 is an exemplary graph of intensity versus time curves 800, 802, 804, and 806, which represent measured signal sets corresponding to respective phototransmitters 486, 484, 488, and 490 for a slide gesture performed by an object such as a hand that moves above sensing assembly 400 of FIG. 4, and specifically illustrates a slide gesture of an object moving from the right side to the left side, as shown by arrow 502 in FIG. 5, across the electronic device. Thus, the object is first closest to phototransmitter 486, then moves across phototransmitters 484 and 488 at roughly the same time, and is then closest to phototransmitter 490.

Similarly, FIG. 9 is an exemplary graph of intensities versus time curves 900, 902, 904, and 906 for a slide gesture by an object moving from top to bottom, as shown as arrow 510 in FIG. 7, across the sensing assembly 400 (denoted here as a vertical gesture), wherein the curves 900, 902, 904, and 906 represent measured signal sets corresponding to respective phototransmitters 484, 486, 490, and 488. In this case, the object moves top to bottom across phototransmitter 484 first, then across phototransmitters 486 and 490 at roughly the same time, and then across phototransmitter 488, with the movement generally centered with respect to the phototransmitters 486 and 490. As shown in FIG. 9, an intensity peak in the measured signal set corresponding to the phototransmitter 484 occurs prior to intensity peaks in the measured signal sets corresponding to phototransmitters 486 and 490, and the intensity peaks in the measured signal sets corresponding to phototransmitters 486 and 490 occur prior to an intensity peak in the measured signal set corresponding to the phototransmitter 488.

The devices 120, 200 and 400 and method 300 are preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure. In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. A wireless communication method, comprising:
providing a wireless communication device with a sensing assembly;
receiving an incoming voice call while on an existing voice call; and
evaluating a gesture, to send the incoming voice call to voicemail via a send gesture, to answer the incoming voice call via an answer gesture or conference the existing voice call with the incoming voice call via a conference gesture.

2. The wireless communication method of claim 1, wherein the send gesture, the answer gesture and the conference gesture are each different from another.

3. The wireless communication method of claim 1, wherein the send gesture, the answer gesture and the conference gesture are intuitive to a user.

4. The wireless communication method of claim 1, wherein the receiving step includes presenting a representation of the incoming voice call and a representation of the existing voice call, defining an incoming call region and existing call region, in a substantially side by side arrangement, on a display.

5. The wireless communication method of claim 1, wherein the send gesture comprises passing an object in a positive X direction above the wireless communication device.

6. The wireless communication method of claim 1, wherein the answer gesture comprises passing an object in a negative X direction above the wireless communication device.

7. The wireless communication method of claim 1, wherein the conference gesture comprises passing an object in a negative Y direction above the wireless communication device.

8. The wireless communication method of claim 1, wherein the conference gesture comprises passing an object in a circular direction above the wireless communication device.

9. The wireless communication method of claim 1, wherein the evaluating step includes utilizing the sensing assembly to determine which gesture was performed.

10. The wireless communication method of claim 1, wherein the evaluating step includes: utilizing the sensing assembly to determine which gesture was performed; and actuating a command to send the incoming voice call to voicemail in response to the send gesture, to answer the incoming voice call in response to the answer gesture or conference the existing voice call with the incoming voice call in response to the conference gesture.

11. A wireless communication method, comprising:
providing a wireless communication device including a display and a sensing assembly;
receiving an incoming voice call while on an existing voice call; and
evaluating a gesture, to send the incoming voice call to voicemail via a send gesture, to answer the incoming voice call via an answer gesture or conference the existing voice call with the incoming voice call via a conference gesture, by: utilizing the sensing assembly to determine which gesture was performed; and actuating a command to send the incoming voice call to voicemail in response to the send gesture, to answer the incoming voice call in response to the answer gesture or conference the existing voice call with the incoming voice call in response to the conference gesture,
wherein the send gesture comprises passing an object in a positive X direction above the wireless communication device,
wherein the answer gesture comprises passing an object in a negative X direction above the wireless communication device,
wherein the conference gesture comprises passing an object in a negative Y direction above the wireless communication device or passing a hand in a circular direction above the wireless communication device.

12. The wireless communication method of claim 11, wherein the receiving step includes presenting a representation of the incoming voice call and a representation of the existing voice call, on the display.

13. The wireless communication method of claim 11, wherein the receiving step includes presenting a representation of the incoming voice call and a representation of the existing voice call, defining an incoming call region and existing call region, in a substantially side by side arrangement, on the display.

14. The wireless communication method of claim 11, wherein the evaluating step includes an object touching the display, the display including a touch screen display.

15. A wireless communication device, comprising:
a housing including a front portion including a display and sensing assembly;
a controller coupled to the housing, the controller configured to control the operations of a wireless communication device; and
a gesture module configured to receive an incoming voice call while on an existing voice call; and evaluate a gesture, to send the incoming voice call to voicemail via a send gesture, to answer the incoming voice call via an answer gesture or conference the existing voice call with the incoming voice call via a conference gesture.

16. The wireless communication device of claim 15, wherein the display includes
a first representation of the incoming voice call and a second representation of the existing voice call, defining an incoming call region and existing call region, respectively, located adjacent to each other on the display.

17. The wireless communication device of claim 15, wherein the send gesture comprises passing an object in a positive X direction, the answer gesture comprises passing an object in a negative X direction and the conference gesture comprises passing an object in a negative Y direction or passing an object in a circular direction, above the wireless communication device.

18. The wireless communication device of claim 15, wherein the gesture module is coupled to the sensing assembly to determine which gesture was performed, and is configured to actuate a command: to send the incoming voice call to voicemail in response to the send gesture, to answer the incoming voice call in response to the answer gesture or conference the existing voice call with the incoming voice call in response to the conference gesture.

19. The wireless communication device of claim 15, wherein the display includes a touch screen display.

20. The wireless communication device of claim 15, wherein the display is configured to display in a portrait mode and a landscape mode.
